(19) United States
(12) Patent Application Publication
(10) Pub. No.: US 2009/0146838 A1
(43) Pub. Date: Jun. 11, 2009

(54) Communication System for Data Acquisition from Remote Devices Applicable for AMR

(75) Inventor: Daniel A Katz, Kiryat Ono (IL)

Correspondence Address: DANIEL KATZ, 87 TZAHAL ST., KIRYAT-ONO, 55451, IL

(73) Assignee: Daniel A. Katz, Kiryat Ono (IL)

(21) Appl. No.: 11/953,054

(22) Filed: Dec. 9, 2007

(51) Int. Cl. G08C 17/00; H04B 7/00

(52) U.S. Cl. 340/870.02; 370/310

(57) ABSTRACT

The present invention discloses a communication system and method for data acquisition and distribution from and to remote devices, applicable for Automatic Meter Reading (AMR), based on ad-hoc mesh networking and mobile relays.

### BACKGROUND OF THE INVENTION

Monitoring and controlling remote devices, spread over wide areas, is required in many fields such as transportation, surveillance, remote sensing, telemedicine and utility (gas, electricity, water, etc.) consumption. Wirelessly communicating remote devices over a wide area is challenging due to technological, logistical, economical, environmental and regulative factors. The deployment and maintenance of thousands and even millions of devices, spread in large cities or entire country, take much time and efforts. Communications with these devices might require additional network infrastructure, frequency licensing and efficient traffic administration. Also, since RF spectrum is limited, nearby systems can introduce interference. One specific application, in demand for an efficient method for remote data acquisition is Automatic Meter Reading (AMR) of utility consumption. Though AMR is a typical and popular application related to the current invention, and particularly addressed here, the scope of this invention is not restricted to AMR, and addresses any application related to wireless monitoring and controlling of remote devices. Thus, terms and expressions specific to AMR, in the context of the current invention, should be interpreted in a wider scope.

Utility meters measure the periodic consumption of the relevant utility, and require to be periodically monitored by the utility company, in order to generate timely billing data and charge consumers accordingly. Often, a utility company has to access thousands and even millions of meters, every month or so, in order to read the data and generate the bills. Such meters might be spread over a wide area, hidden or blocked by all kinds of urban and countryside obstacles, such as fences, closed doors, dogs, etc. Physically accessing and reading these meters can be a complex, time consuming and costly task.

The reading of utility meters was traditionally performed manually, by persons that physically accessed the meter at the customers' premises. This method is still quite popular worldwide, especially where man power cost is low.

Over time, manual meter reading has been enhanced with walk-by or drive-by RF reading systems. Meters, which can be read remotely, have been developed, furnished with small and low cost radios. Due to small dimensions of meter and radio, sometimes obscured location, battery limitations and regulative transmission power restrictions, communications range is typically limited. In the absence on any further radio network, this method requires the meter to be polled on a regular basis by an interrogator, either portable or vehicular, typically necessary to get in close proximity to the meters, therefore still travel intensively.

This style of meter reading, sometimes referred to as mobile AMR (MAMR or mAMR), allows meter reading to be completed without direct access to the meter. Various techniques for mAMR are known in the art, such as those described in the following US patents.

U.S. Pat. No. 7,248,181 to Patterson et al. discloses an automated meter reading (AMR) system, including a 1 mw unlicensed transmitter activated about every 30 seconds, to be read by a field operator walking or driving in close proximity to the system.

U.S. Pat. No. 7,116,243 to Schleich et al. discloses an automatic meter reading (AMR) system and a method, reducing or eliminating the need to physically visit a remote residential utility meter, providing two-way wireless communication between a mobile reader and a plurality of remote endpoint devices.

U.S. Pat. No. 7,109,882 to Angelis et al. discloses a mobile AMR system, allowing the sequencing of meters in a meter reading route. Upon reading a meter, the mobile reader receives an input used in identifying a next meter to be read on the meter reading route.

Yet, those mAMR methods known also as drive-by or walk-by AMR, are not fully automated, require dedicated reading staff and establishing a direct link between the reader and every meter radio, thus require much reading efforts, sensitive to human costs and faults.

More recently, over the last few years, new methods were developed to automate meter reading by installing or using communication networks that allow data to flow from the meter to a central station without human intervention. Such systems have been referred to in the art as Automated/Automatic Meter Reading (AMR) systems. In addition to the direct save in human labor, AMR presents further advantages such as: protect employees from danger, detect theft, reduce sensitivity to human errors, provide flexible and frequent billing and obtain archive information to help resolve billing disputes.

Basically, AMR networks are divided in two major groups: a) AMR dedicated communication networks; or b) Public communication networks (i.e. cellular, Internet), used also for AMR. For the utility company, dedicated networks can be better tailored to AMR, enabling low cost radios, optimal location of base stations, no transmission fees and full control over the network. However, such networks are expensive to deploy and to maintain, usually require dedicated real estate, frequencies, and often are in continuous conflict with environmental protectors and regulators. AMR over public networks, on the other hand, is subject to restricted quality of service, operational fees, expensive transmitters, etc. Therefore, the prior art introduces a variety of AMR networking solutions, based on dedicated radio networks as well as on public communication networks.

Various communications media are known in the art for AMR, such as: radio, cellular, telephone, power lines, fiber optic, etc.

In recent years, public communication networks, particularly cellular and Internet infrastructure, were widely been deployed, offering good coverage and fair operational fees. Consequently, AMR methods based on such networks were been developed and disclosed.

U.S. Pat. No. 4,866,761 to Thornborough et al. discloses an automatic meter reading system arranged for connection to customers' telephone lines.

U.S. Pat. No. 5,897,607 to Jenney et al. discloses an automatic meter reading system transmitting the measurement as an email message over the Internet.

U.S. Pat. No. 6,069,571 to Tell discloses an apparatus and method for collecting meter data, transmitting utility usage data over a control channel of a wireless cellular communication.

U.S. Pat. No. 6,014,089 to Tracy et al. discloses a method for transmitting data using a digital control channel of a wireless network, using the short message service (SMS) control channel.

U.S. Pat. No. 6,246,677 to Nap et al. discloses an AMR communication system based on a two-way spread spectrum Local Area Network and a commercially available fixed Wide Area Network.

Yet, though AMR based on public radio networks saves installation and maintenance costs, it might be subject to operational fees and usually requires relatively expensive meter radios. Thus, this approach is not straight forward.

U.S. Pat. No. 4,396,915 to Farnsworth et al. discloses a remote automatic utility reading system for reading the measurement of a commodity over a power line.

U.S. Pat. No. 7,248,158 to Berkman et al. discloses an automated meter reading power line communications system, where meter reading is first transmitted wirelessly, then relayed to a power line transmitter.

Power lines obtain a very good network topology for AMR however present quite a hostile communications environment, due to noise, sensitivity of electrical appliances (TV and radio tuners) and restricting regulations.

A cost effective radio network dedicated for AMR is challenging due to technology barriers and strict regulations that require solutions not always justified for a niche application. For example, regulation limits the transmission power of a radio, bounding its communications range, consequently requiring additional base stations to relay meter's data to a central station. Another regulatory restriction is concerned with RF spectrum, limiting the usage of frequency bandwidth, often requiring AMR networks to share spectrum with other applications operating in the same area.

Several methods were been suggested in the prior art, related to dedicated wireless networks for ARM.

U.S. Pat. No. 6,684,245 to Shuey et al. discloses an automated meter reading system comprising utility meters and an infrastructure of communication nodes, each node communicating with a number of predefined meters, and a plurality of gateways, each gateway communicating with a number of nodes, a wide area network to communicate with the gateways and with a host server.

U.S. Pat. No. 6,172,616 to Johnson et al. discloses a wide area communications network for communicating data from a plurality of network service modules through a plurality of remote cell nodes and intermediate data terminals to a central data terminal, having a layered network with a hierarchical communications topology

Still, dedicated fixed radio networks for AMR are not always cost effective and dedicated network installation and operation costs are not easily justified, business wise.

A variation or special case of dedicated radio networks for AMR is wireless ad-hoc networks, known also as mesh networks. A wireless mesh is a wireless cooperative communication infrastructure among a massive number of individual wireless transceivers that has a network routing capability. Mesh networks are self-healing: the network can still operate even when a node breaks down or a connection goes bad. As a result, a very reliable network is formed and additional network infrastructure is saved. This concept can be applicable for AMR, where meter units implement mesh nodes logic. There are various ways to implement wireless mesh networks, regarding RF management, routing algorithms, redundancy strategies, bandwidth and latency considerations, etc.

U.S. Pat. No. 7,304,587 to Boaz, discloses an automated meter reading network system, including multiple meter data collectors forming a wireless mesh communications network, and a host computer in communication with the meter data collectors either directly or through multiple field host data collectors, which can be connected to the host computer through a wide area network. The host computer runs a program adapted to manage the mesh communication network.

U.S. Pat. No. 6,873,245 to del Castillo et al. discloses an RF remote appliance control/monitoring network. This invention is directed to remotely distributed configurations, such as a building plant that includes a distributed array of appliance, a service facility such as a hotel, motel, hospital, shopping mall, manufacturing facility, etc. Each of such buildings is been communicated by satellite.

Ad-hoc or wireless mesh networks often present a challenge to define the best route to communicate between a source node and a destination node. The prior art provides many approaches to that issue, particularly dynamic methods to build such a routing table during operation, as existing nodes might fail and new nodes are installed. One such method is taught by the following US patent.

U.S. Pat. No. 7,035,207 to Winter et al. discloses a System and method for forming, maintaining and dynamic reconfigurable routing in an ad-hoc network, as following:

A network comprises a plurality of nodes; each node has a unique ID, and stores a table of nodes. The table entry includes three fields: a destination node field, a next node field and a cost field. The next node is a node ID corresponding to the next node in the communication path to the destination node. The cost is the cost associated with communication with the destination. When a node is added to the network, it detects the presence of adjacent nodes. The new node obtains the table stored in each adjacent node and uses that information to update its own table, thereby obtaining information for communicating with every other node in the network, wherein the destination address of the new entry is the same as in the adjacent node entry, the next node address of the new entry is the ID of the adjacent network node and the cost value is the sum of the cost value in the adjacent node entry and the cost of communicating with the adjacent node. Each of the adjacent nodes obtains information related to communicating with the new node, adjusts its own table of nodes accordingly, and sends update information to nodes adjacent to it to propagate knowledge of the new node. Changes in the network are propagated between network nodes by periodic exchange and updating of node tables. Updating can be performed at a pre-determined time and/or in response to a change in the network.

U.S. Pat. No. 7,187,906 to Mason, Jr. et al. discloses a method and system for configurable qualification and registration in a fixed network AMR system. That method teaches how to define a relative hierarchy of nodes, in a wireless network, by checking the two-way communications quality among neighbor nodes.

U.S. Pat. No. 7,089,089 to Cumming et al. discloses an energy monitoring device including procedures for secure communications. The energy monitoring device is further capable of communications via an ad-hoc “mesh” network, thereby facilitating communications among devices which are substantially inaccessible due to either physical or economic limitations.

The low traffic nature of AMR usually suits the mesh concept; however in many cases mesh cannot provide a full proof solution for AMR. Mesh networks could efficiently route meter records among a group of nearby meters, e.g. in same building, however due to the low power nature of meter radios, this concept will not easily deal with large gaps between meters, or groups of meters, as introduced by large non residential buildings and yards, parks and gardens, lakes and rivers, wide highways, train and bus stations, parking lots, etc.

Israeli patent 145737 to Katz discloses a system and method for AMR that enables using short range radios and also enables operation with no additional base stations. That invention considers the specific nature of AMR communications which typically obtain very low traffic and much redundancy (a small data packet might be communicated within a month). The invention teaches AMR based on a radio network, yet instead of using a fixed infrastructure to implement the network, it proposes mobile relays to replace base stations. This way, many issues concerned with fixed radio networks are avoided, and consequently the system gains a much shorter installation time, as well as lower installation and maintenance costs. Also, employing mobile relays instead of fixed base stations enables using less relay nodes overall, since the same mobile relay can be used in different areas, at different times, because AMR does not require simultaneous and continuous communications with all meters. Also, enabling the use of low cost meter radios, that invention provides a significant advantage over AMR methods based on public networks.

Israeli patent 145737 introduces another advantage over prior art, particularly over methods known as “walk-by” or “drive-by” or “mobile AMR”. This patent teaches AMR based on mobile relays that travel randomly or semi-randomly related to meters locations or not necessarily aware to meters locations, i.e. save dedicated meter reading staff. For example, Bluetooth enabled meters can be read by Bluetooth enabled mobile phones carried by passing-by pedestrians or by radios installed in taxis or buses doing their routine work. However, when mobile relays are deployed and roam randomly or semi-randomly, i.e. do not travel systematically to get closer to meters, as Israeli patent 145737 teaches, it is difficult to ensure or predict a successful delivery of data from a meter to the central station. This drawback is particularly pertinent in dense urban areas, where meters may be installed in basements, high floors, or other locations far away or blocked (for communication purposes) from routes where the mobile relays might travel.

The present art methods described above have not yet provided satisfactory solutions to the problem of efficient and cost effective remote AMR.

It is an object of the present invention to provide a system and a method for AMR, based on radio networks.

It is still another object of the present invention to provide a system and method for AMR, by using meter transceivers that are small, inexpensive, low power consuming and low power radiating.

It is another object of the present invention to provide a system and a method for AMR, by utilizing mobile relays, minimizing the costs and complications concerned with fixed base station.

It is still another object of the present invention to provide a system and a method for AMR, by utilizing mobile relays, not necessarily operated by dedicated staff, minimizing the costs and complications concerned with dedicated mobile AMR.

It is yet another object of the present invention to provide a system and method for AMR, by applying ad-hoc networking schemes, utilizing meter radios as repeaters, saving network infrastructure costs, to propagate data records from meters to a central station, in a “store and forward” manner.

It is still another object of the present invention to provide a system and method to monitor and control remote devices spread over a wide area, flowing data from end points to a central station and vice versa, enabling remote monitoring as well as remote controlling and actuating.

Other objects and advantages of the invention will become apparent as the description proceeds.

### SUMMARY OF INVENTION

The invention is directed to a communication system and method for data acquisition and distribution from and to remote devices, applicable for Automatic Meter Reading (AMR), comprised of:
a) a meter unit coupled to each meter, said meter unit comprised of: i) an I/O (Input/Output) interface; ii) a memory device storing a unique identification number (ID); iii) an RF transceiver (i.e. transmitter+receiver); iv) a microcontroller;
b) at least one mobile relay comprised of: i) an RF transceiver; ii) a memory device; iii) a microcontroller;
c) a central station comprised of: i) a central computer; ii) an RF transceiver;
   wherein said meter unit configured to periodically read its meter and store a data record containing at least said reading and said meter's ID, and forward stored data records to other meter units and mobile relays in its vicinity, and alter and store received data records, said mobile relay configured to automatically communicate data records from a meter unit to said central station, wherein at least one of said data records arrived from another meter.

This way, a wireless network is established, configured to propagate data from meters to the central station, wherein data records hop from meter to meter, and assisted by mobile relays, ultimately arrive to the central station. Basically, communication between low power meter units is effective over short distances, while mobile relays bridge over long gaps between meters and the central station, introduced by large non residential buildings and yards, parks and gardens, lakes and rivers, wide highways, train and bus stations, parking lots, etc. As a result, fixed network infrastructure is saved, but it is also not necessary for mobile relays to directly communicate with every single meter unit.

Mobile relays may travel along predefined routes, yet may also travel randomly or semi-randomly related to meters locations, not necessarily aware to meters locations, i.e. saving dedicated meter reading staff, as taught by Israeli patent 145737 issued to Katz. For example, meter units can be based on Bluetooth transceivers, and mobile relays can be Bluetooth enabled cellular phones carried by passing-by pedestrians or public transportation vehicles as taxis and buses.

As already indicated, AMR is a typical application related to the current invention and is particularly addressed here, yet, the scope of this invention is not restricted to AMR, and addresses any application related to wireless monitoring and controlling remote devices. In this context, the current invention teaches how can data flow or propagate from end points to a central station and vice versa, enabling remote monitoring as well as remote controlling and actuating. Furthermore, a “meter” in the scope of the present invention, may be interpreted as a utility meter in the context of AMR, yet it can be any remote controlled/monitored device, configured to input control signals and/or output status signals, upload and/or download data, such as a parking meter, surveillance camera, seismic recorder, etc. Some non restricting examples to meter applications, in the scope of this invention are: utility (gas, electricity, water); environmental (pollution, temperature, barometric pressure, humidity); seismic/water flow; surveillance (video, audio, access control); traffic (parking, speed control, traffic light monitoring and control); military reconnaissance; industrial (gas/oil/water/drilling or processing); vehicular monitoring (tachometer/speed recorder, toll payment); body carried/worn (heart monitor, blood pressure/diabetic monitor).

Basically, the current invention teaches how data can flow or propagate from meter to meter, in a store and forward way, and then be communicated to the central station by a mobile relay. Yet, it is possible that mobile relays will forward data also to other mobile relays or meter units.

The basic meter's data record contains the meter reading and its ID, still this record may include further information, in additional data fields, such as: a) meter's reading time of day (TOD, i.e. time and date); b) meter's status as battery condition and hardware failure; c) for each retransmission (“hop”) of a record: i) transmitting unit ID; ii) transmission TOD; and d) accumulated number of hops made so far.

The prior art discloses many ways to route data packets between far away nodes in a wireless ad-hoc or mesh network, such as U.S. Pat. No. 7,035,207 to Winter et al. The present invention is not restricted to a specific routing method, yet it teaches one method that is particularly applicable for AMR. In this context, AMR is considered a special application of wireless ad-hoc networks, where the final destination of all data packets is unique, i.e. the central station where all meter records are stored and processed for the utility company. Also, the present invention is aware of communication gaps that might be present between meters and the central station, due to the low power nature of meter radios, as well as large distances and RF propagation obstacles often introduced in such locations. Such communication gaps might not be possible to be answered only by ad-hoc networking schemes, thus the present invention suggest employing also mobile relays.

As a result, the present invention suggests an approach that combines ad-hoc networking and mobile relay capabilities. Basically, this approach is directed to propagate and consolidate data records of adjacent meters, employing significant redundancy, and then use a mobile relay to communicate the consolidated data records from a meter unit to the central station.

The propagation and consolidation of data records is employed according to the following steps carried out by each meter unit: a) read meter and store record; b) transmit own data record; c) receive data record transmitted by another meter; d) store the received data record (unless already stored); and e) retransmit stored data record (unless previously transmitted by the same unit, or if traveled over too many hops, or if old/invalid record, etc.). When a mobile relay gets near and communicates with a meter unit, data records stored in said meter unit are communicated to that mobile relay, and then the meter unit memory may be overwritten.

Still, the current invention is not restricted to that data routing/propagation/consolidation method and may employ any alternative scheme of routing data packets over ad-hoc wireless networks.

Also, the current invention does not dictate any specific communication timing/synchronization algorithm. It is not a trivial challenge to successfully communicate data among multiple transceivers, sharing a limited RF spectrum and subject to severe energy consumption and radiation restrictions. Yet many such methods are known in the art, and may be applicable here. In this context, the current invention does not restrict which transmitter initiates the communications, how do multiple transmitters access the network (e.g. TDMA—Time Division Multiple Access; FDMA—Frequency Division Multiple Access; CDMA—Code Division Multiple Access; OFDMA—Orthogonal Frequency Division Multiple Access), how and when receivers turn on.

Synchronization among RF transceivers comprised in various parts of the system, according to the current invention, can be achieved by internal clocks, comprised in (or by) said transceivers, and also by input signals derived from external sources. Nevertheless, meter units usually operate on small batteries, so subject to severe power consumption restrictions, while mobile relays may be mounted on vehicles and access a much generous energy source, so in this aspect it might be beneficial to keep the mobile relay receiver always on, and also frequently transmit inquiry signals from the mobile relay, in order to detect nearby meter units.

Further, the current invention does not dictate any specific spectral technique, and any of the following may be applied: single frequency; SS (Spread Spectrum); FHSS (Frequency Hopping Spread Spectrum); and DSSS (Direct Sequence Spread Spectrum). Yet, typically, regulations allow SS radios to employ a higher transmission power, gaining longer distances, operating on unlicensed ISM (Industrial, Scientific and Medical) bands, as 900 MHz, 2.4 GHz and 5.8 GHz. Thus, ISM radios as Bluetooth and WLAN (IEEE 802.11) and ZigBee might be suitable for embodiments of the present invention.

Basically, mobile relays communicate with the central station wirelessly. Yet, this connection may employ a more complex scheme, including further wireline and/or wireless communication links. For example, the central station may employ a server which can be accessed (securely) over the Internet, and mobile relays may utilize a cellular modem, operating on a cellular network through which the Internet may be accessed, enabling data flow between said mobile relay and the central station's server. Alternatively, mobile relays may communicate the central station over other types of networks, such as Wi-Fi, or Wi-Max, as well as cellular.

The invention is also directed to a meter unit coupled to a meter, for AMR, configured to periodically read its meter and store a data record containing at least said reading and said meter's ID, and forward stored data records to other meter units and mobile relays in its vicinity, and alter and store received data records, said mobile relay configured to automatically communicate data records from a meter unit to said central station, wherein at least one of said data records arrived from another meter.

The invention is further directed to a mobile relay, for AMR, configured to communicate with meter units in its vicinity, said meter unit coupled to a meter and configured to periodically read its meter and store a data record containing at least said reading and the meter's ID, and forward stored data records to other meter units and mobile relays in its vicinity, and alter and store received data records, said mobile relay configured to automatically communicate data records from a meter unit to a central station, wherein at least one of said data records arrived from another meter.

The invention is yet directed to a central station, for AMR, configured to communicate with mobile relays, said mobile relay configured to communicate with meter units in its vicinity, said meter unit coupled to a meter and configured to periodically read its meter and store a data record containing at least said reading and the meter's ID, and forward stored data records to other meter units and mobile relays in its vicinity, and alter and store received data records, said mobile relay configured to automatically communicate data records from a meter unit to said central station, wherein at least one of said data records arrived from another meter.

Other objects and advantages of the invention will become apparent as the description proceeds.

### BRIEF DESCRIPTION OF DRAWINGS

The above and other characteristics and advantages of the invention will be better understood through the following illustrative and non-limitative detailed description of preferred embodiments thereof, with reference to the appended drawings, wherein:

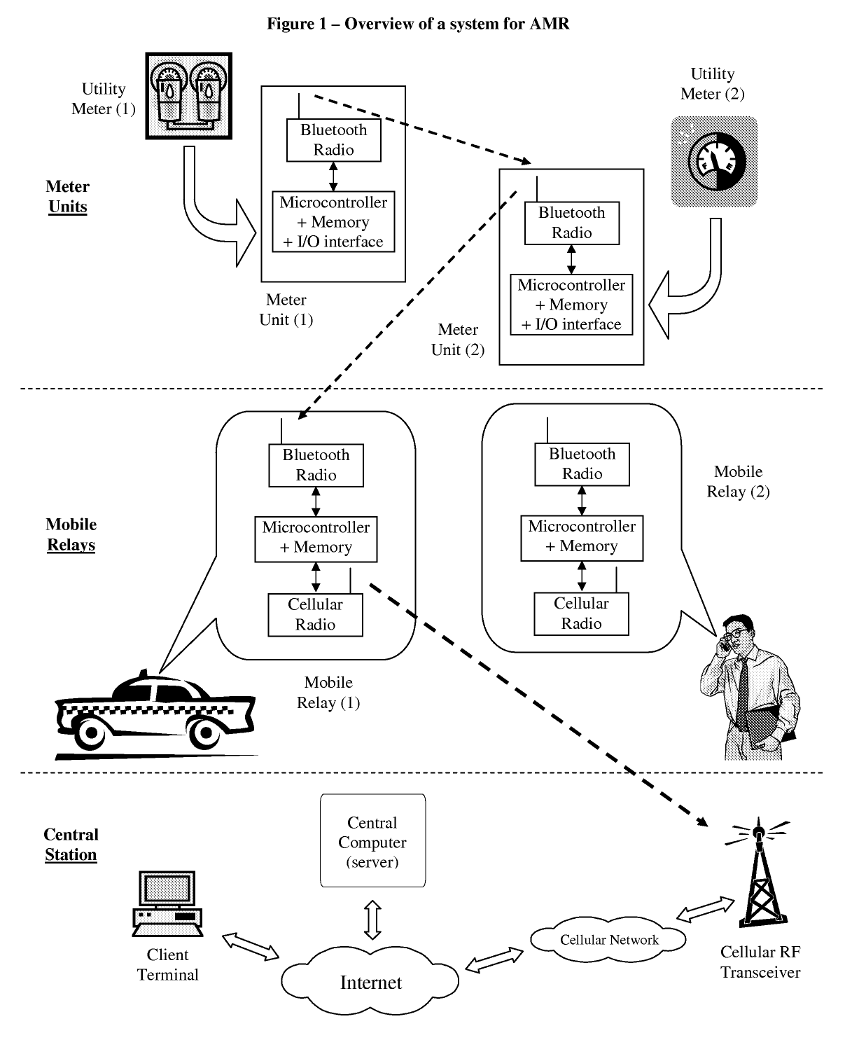

FIG. 1 illustrates an overview of a system for AMR, comprised of meter units, mobile relays and a central station; wherein:
a) Two meter units are shown, each coupled to a utility meter;
b) Two mobile relays are shown: mobile relay (1) in operation and mobile relay (2) for illustration purposes only.
c) A central station comprised of a central computer (client+server) and an RF transceiver, implemented as part of a cellular network.

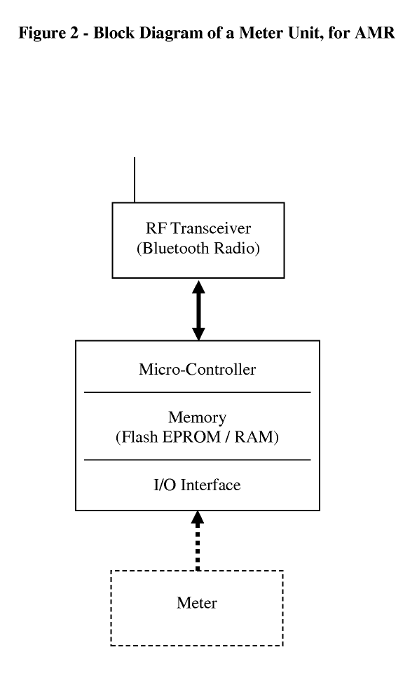

FIG. 2 illustrates a block diagram of a Meter Unit for AMR, comprised of an I/O interface, a memory device, an RF transceiver and a microcontroller; wherein:
a) The RF transceiver is based on a Bluetooth integrated radio chip;
b) The microcontroller+memory device+I/O interface are implemented in one integrated circuit (IC) device.

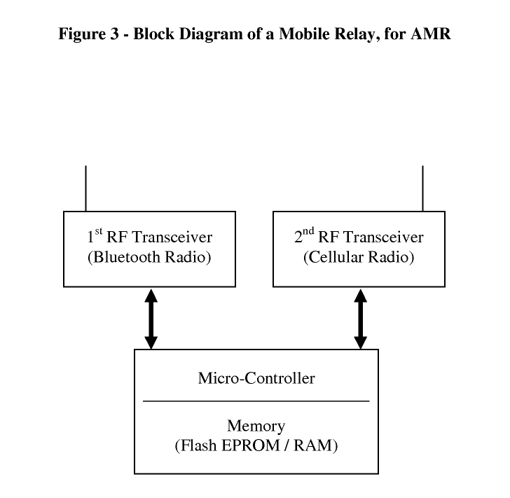

FIG. 3 illustrates a block diagram of a Mobile Relay for AMR, comprised of an RF transceiver, a memory device and a microcontroller; wherein:
a) The microcontroller+memory device are implemented in one integrated circuit (IC) device;
b) The RF transceiver is implemented in two separate transceivers:
   i. 1^{st} RF transceiver based on a Bluetooth integrated radio chip (communicate with meter units);
   ii. 2^{nd} RF transceiver based on a cellular radio modem (communicate with central station).

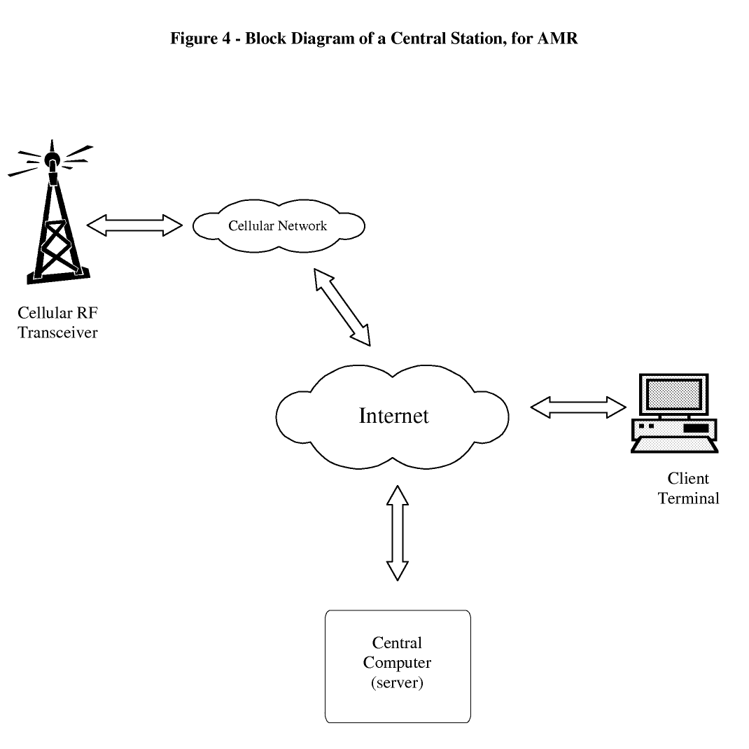

FIG. 4 illustrates a block diagram of a Central Station for AMR, comprised of a central computer and an RF transceiver; wherein:
a) The central computer is implemented as following:
   i. A server computer with access to the Internet;
   ii. A client terminal configured to access the server over the Internet;
b) The RF Transceiver is implemented as part of a cellular network, obtaining connectivity with the central computer over the Internet, and over the cellular network. For simplicity reasons, only parts of the cellular network are shown.

### DETAILED DESCRIPTION

The invention will now be described with respect to various embodiments. The following description provides specific details for a thorough understanding of, and enabling description for, these embodiments of the invention. However, one skilled in the art will understand that the invention may be practiced without these details. In other instances, well-known structures and functions have not been shown or described in detail to avoid unnecessarily obscuring the description of the embodiments of the invention.

The invention is directed to a communication system and method for data acquisition and distribution from and to remote devices, applicable for Automatic Meter Reading (AMR), comprised of:
d) a meter unit coupled to each meter, said meter unit comprised of: i) an I/O (Input/Output) interface; ii) a memory device storing a unique identification number (ID); iii) an RF transceiver (i.e. transmitter+receiver); iv) a microcontroller;
e) at least one mobile relay comprised of: i) an RF transceiver; ii) a memory device; iii) a microcontroller;
f) a central station comprised of: i) a central computer; ii) an RF transceiver;
   wherein said meter unit configured to periodically read its meter and store a data record containing at least said reading and said meter's ID, and forward stored data records to other meter units and mobile relays in its vicinity, and alter and store received data records, said mobile relay configured to automatically communicate data records from a meter unit to said central station, wherein at least one of said data records arrived from another meter.

An overview of a preferred embodiment of the invention is illustrated in FIG. 1.

Referring to FIG. 2 which illustrates a block diagram of a Meter Unit for AMR, in a preferred embodiment, the RF transceiver is a Bluetooth integrated radio chip based on CSR's BlueCore IC family; a reference specification can be read here—http://www.csr.com/products/bc6rom_spec.htm. Additionally, a 100 mw power amplifier is connected to the transmitter's output, achieving a transmission level of 20 dBm (Bluetooth “class 1”), without violating the FCC regulations for unlicensed ISM radios. As well practiced in the art, Bluetooth radios employ FHSS (Frequency Hopping Spread Spectrum) communications over the 2.4 GHz band, as well as TDMA (Time Division Multiple Access) and FDMA (Frequency Division Multiple Access).

In this preferred embodiment, the [microcontroller+memory device+I/O interface] are implemented in one integrated circuit (IC) device, based on Texas Instruments TI MSP430 single chip microcontroller family; for a brochure see—http://focus.ti.com/lit/ml/slab0341/slab0341.pdf. Among other tasks, the microcontroller is responsible for control and monitor of TOD (Time of Day), i.e. the current time and date. In a preferred embodiment, internal TOD managed by different units are synchronized with each others, upon communicating, to compensate for clock drifts.

Referring to FIG. 3, a similar TI microcontroller may be used to implement the mobile unit, and similar CSR BlueCore radio IC may be used as 1^{st} RF transceiver, with an additional 100 mw power amplifier as well. The preferred embodiment employs different types of radios for the meter unit and the central station, so the mobile relay is furnished with two types of radios as well. The 2^{nd} RF transceiver comprised in the preferred embodiment of a mobile relay is a cellular radio modem, e.g. GSM/GPRS. There are many off the shelf such radio modems, such as:

a) Nokia 30 GSM Connectivity Terminal; see user's guide at—http://nds1.nokia.com/phones/files/guides/Nokia_{—}30_UG_en_.pdf; and specifications at—http://nds1.nokia.com/BaseProject/Sites/NOKIA_MAIN_{—}18022/CDA/Categories/Buesiness/Machine-to-Machine/WhatisM2/_Content/_Static_Files/n30_datasheet-v4.pdf
b) Motorola g18 GSM/GPRS embedded module. See developer's guide at—http://www.motorola.com/mot/doc/0/957_MotDoc.pdf; and specifications at—http://www/avnet.co.za/New_Products/Motorola/GSM/g20/g20_Module.htm
c) Alpha Micro AMC200XT Embedded GPRS/GSM Modem with Integrated TCP/IP. Specifications—http://www.alphamicro.net/components/product˜line˜4˜id˜482.asp

The central station, illustrated in FIG. 4, can be implemented based on popular products as it is well practiced in the art.

In the preferred embodiment, mobile relays are mounted on vehicles, belonging to fleets of vehicles that drive frequently in the area where the meters are installed, preferably covering all main streets and roads in that area. Preferably, these fleets include: garbage collecting trucks, street cleaning vehicles, public buses, trams and security patrol cars. This strategy ensures that any meter located at most 50 meters of a street or road will be accessed and read by a mobile relay, as expected with 20 dBm Bluetooth radios. In addition, since less RF noise is usually present on Bluetooth bands at night, fleets operating at night, such as garbage collecting trucks, may significantly contribute to the preferred embodiment, as well as security patrol cars concerning communications on weekends.

Meters located beyond that, are expected to be relayed by other meter units in between. For that purpose, the preferred embodiment is configured to allow up to 5 hops, i.e. enabling a data record to propagate 5 segments (i.e. 5 retransmissions) from its origin. This can be achieved by configuring a meter unit to forward data records which indicate that “accumulated number of hops made so far” does not exceed 4.

A data record contains, in the preferred embodiment, the following fields: a) meter's ID; b) meter's reading; c) Reading time and date; d) meter's status of battery residual capacity and BIT (Built In Test) results; e) IDs of retransmitting units; f) accumulated number of hops made so far.

As already indicated, mobile relays are preferably mounted on vehicles, so enjoy a practically unlimited supply of energy. Thus, Bluetooth transceivers of mobile relays never enter power save mode, but constantly try to contact any meter unit nearby. Also cellular transceivers of mobile relays and central station have no energy consumption limitations, so connectivity between mobile relays and the central station is always available. Meter units, on the other hand, are configured to turn on and communicate periodically, and sleep for the rest of the time, in order to save battery power.

The specific timing of meter unit's communications may vary from one embodiment to another, typically depending on specific system and deployment and application requirements. Basically, as units communicate more frequently, the chance to successfully deliver data records increases; however meter unit's battery life decreases. Furthermore, the way the devices are grouped in different networks and the way the data packets are routed along these networks also affect the performance of the system. In this context, the present invention is not restricted to specific communications timing and/or networking method, yet the preferred non-limitative embodiment is based on Bluetooth technology, which among other properties, provides functionality for ad-hoc networking. Bluetooth defines and supports a “piconet”—network with up to 8 members, one of which is a “master”, which controls the piconet, and others are “slaves”; and a “scatternet”—a number of interconnected piconets. Scatternets can be formed when a member of one piconet (either master or slave) participates in another piconet. The device participating in both piconets can relay data between members of both ad-hoc networks, enabling communicating data packets far beyond Bluetooth's single link limited range.

Although Bluetooth was initially designed for cable replacement between small devices, it is currently considered as a potential enabler for ad hoc networking applications due to the scatternet concept. The preferred embodiment of the current invention takes advantage of the ad hoc networking functionality of Bluetooth scatternets, as well as synchronization and other properties of Bluetooth piconets, and operational modes of Bluetooth devices.

For better understanding of the Bluetooth standard and technology, and get familiar with some related network forming and packet routing methods, one may refer to the following sources of information:

### 1) Book—

### BLUETOOTH Connect Without Cables

### By Jennifer Bray and Charles F Sturman

### © 2001 Prentice Hall PTR

2) Web site—
www.bluetooth.com

### 3) Paper—

### Performance of Symmetric Neighbor Discovery in Bluetooth Ad Hoc Networks

### Diego Bohman, Matthias Frank, Peter Martini, Christoph Scholz

Institute of Computer Science IV, University of Bonn, R″omerstraβe 164, D-53117 Bonn
http://web.informatik.uni-bonn.de/IV/Mitarbeiter/scholz/10_Bohman.pdf

### 4) Paper—

Mobility Management in Bluetooth ad hoc networks

### Osok Song, Chaegwon Lim, and Chong-Ho Choi

### Samsung Electronics/School of Electrical Engineering and Computer Science, and ASRI, Seoul

### National University, Seoul, Korea

http://cls/snu.ac.kr/publication/paper/JCCI_BMR_final.pdf

Following is a non-limitative description of network forming, as well as timing and synchronization, among RF transceivers (also known as network “nodes”) comprised in meter units and mobile relays, according to a preferred embodiment, based on the Bluetooth standard (IEEE 802.15).
a) Periodically, each transceiver is configured to semi-randomly alternate between scan inquiry mode, enabling adjacent transceivers to discover it, and inquiry mode, trying to discover new transceivers installed nearby or passing by, on specific pre-defined time slots.
b) When a meter unit discovers another meter unit, it either joins that piconet, if a master was discovered, or establishes its own piconet, as master, if a slave (connected or isolated) was discovered.
c) Transceivers belonging to same Piconet, which are synchronized among themselves (Bluetooth property), are configured to enter active mode and establish piconet connections periodically (e.g. at 4 am; 12 am; and 8 pm, every third day), on semi-random times, defined in advance and communicated to all piconet members by the piconet master.
d) During each active period, every meter unit is configured to: i) read its meter and store an accordingly data record in memory; ii) communicate all stored records, except those which already made 5 hops, to all other piconet members; also, a meter unit does not forward a data record back to the meter unit from which this record was received; iii) receive data records from other piconet members; iv) store the received data records, unless invalid.
e) When a meter unit discovers a mobile relay or vice versa, an ad-hoc connection is established and all data records stored in the meter unit are communicated to the mobile relay, then erased from said meter unit memory.

The duty cycle of inquiry scanning is a major design parameter, since longer scanning time means a better probability to successfully deliver data records, yet shorter battery life. For such and similar reasons, Bluetooth radio designers make many efforts to cut scanning power consumption. CSR, one of the major worldwide Bluetooth IC providers, recently made a significant contribution to that case, adding “conditional scan” and “casual scan” modes that can save up to 86% of Bluetooth's power consumption in scan mode. When using conditional scan, the BlueCore IC will wake up the minimum parts of the radio to perform a quick scan for any activity in the 2.4 GHz band, if the radio discovers activity, it will initiate a normal Bluetooth page scan/inquiry. If not, the radio will remain asleep. The casual scan mode synchronizes the periodic wake up of BlueCore with that of the attached baseband device, e.g. a microcontroller; consequently BlueCore does not wake it up unnecessarily.

Time synchronization among RF transceivers, particularly those comprised in meter units, is also a crucial factor in the disclosed invention, since said transceivers are usually kept in power save mode for a long time, and wake up for relatively short periods of time to communicate with each other. Thus, it is important that adjacent RF transceivers wake up and be active, particularly performing inquiry and inquiry scan, more or less simultaneously, to increase communication success probability. Several methods may be applied to achieve such time synchronization, and the present invention is not restricted to any specifically. Yet, the preferred embodiment uses Bluetooth built in clocks and piconet synchronization for that purpose. In another embodiment, input signals from external sources can control that timing.

In a different embodiment of the present invention, RF transceivers comprised in meter units and mobile relays are unlicensed WLAN IEEE 802.11 transceivers. Differently from Bluetooth, which is connection oriented at the data link layer, 802.11 is connectionless. This means that data link connections have to be explicitly setup. In 802.11-based ad hoc networks a single broadcast channel is shared by all devices using the carrier sense multiple access/collision avoidance (CSMA/CA)-based MAC. Thus, the distance among nodes defines the network topology.

Mobile relays communicate with the central station, preferably, over a GSM/GPRS cellular network and the Internet. Thus, and since said cellular transceivers are preferably always powered on, the connection between mobile relays and the central station is always available. Therefore, data is communicated between mobile relays and the central station, or vice versa, preferably upon been updated. Alternatively, mobile relays may communicate the central station over other types of networks, such as Wi-Fi, or Wi-Max, as well as cellular. A secure connection is applied between a mobile relay and the central station server in order to prevent unlawful actions, as commonly practiced in the art. Client computers are configured also to access the central station server securely, typically to control the system and process the data by the AMR network administrator.

As indicated already, “meter” in the scope of this invention may be interpreted as any remote controlled and/or monitored device, such as: utility (gas, electricity, water); environmental (pollution, temperature, barometric pressure, humidity); seismic/water flow; surveillance (video, audio, access control); traffic (parking, speed control, traffic light monitoring and control); military reconnaissance; industrial (gas/oil/water/drilling or processing); vehicular monitoring (tachometer/speed recorder, toll payment); body carried/worn (heart monitor, blood pressure/diabetic monitor).

According to one aspect of the invention, an AMR system based on the present invention is implemented by a utility company in a village or town or city borough. Meter units are Bluetooth enabled; mobile relays are Bluetooth enabled cellular phones. The utility company offers a money discount to any customer that owns a Bluetooth enabled mobile phone, and accepts that his phone will act as a mobile relay in that AMR system. To implement that, a small size JAVA application has to be downloaded from the company's web site, installed and operated in the customer's phone. Every time that he passes by a meter unit, his phone is ready to automatically relay data records stored there, derived from this and other meters, to the utility company, by establishing a Bluetooth connection with the nearby meter unit, then a TCP/IP connection with the company's central station Internet server. If enough customers accept that offer, the utility company saves installation and operation costs, while customers enjoy a nice and easy income.

According to another aspect of the invention, an AMR system based on the present invention is implemented by a municipality. Meter units are provided with ISM unlicensed radios, mobile relays comprise compatible ISM radios and also connected to the municipality VHF radio network. Mobile relays are mounted on vehicles that belong or subcontract or engaged with the municipality, including: garbage collecting trucks, street cleaning vehicles, school buses, city buses and trams, police cars, infrastructure maintenance vehicles, etc. Meter units are configured to propagate data records to other meter units, up to 5 hops away. The vehicles, as they drive through the city, constantly try to communicate with meters. When such a contact is made, all data records stored in that meter unit are communicated to the mobile relay, then forwarded to the central station over the municipal VHF network.

The above examples and description have of course been provided only for the purpose of illustration, and are not intended to limit the invention in any way. As will be appreciated by the skilled person, the invention can be carried out in a great variety of ways, employing more than one technique from those described above, all without exceeding the scope of the invention. In this context, though the invention specifically refers to AMR (Automated Meter Reading), it is definitely not bounded by this particular application, as it addresses any requirement for monitoring and control remote devices spread over a wide area. Furthermore, a “meter” in the scope of the current invention, is interpreted as a utility meter in the context of AMR, yet in the scope of the present invention it can be any remote controlled device, configured to input control signals and/or output status signals, or upload and/or download data, such as a parking meter, a surveillance camera, a seismic recorder, etc.

The invention claimed is:

1. A communication system and method for data acquisition and distribution from and to remote devices, applicable for Automatic Meter Reading (AMR), comprised of:
a) a meter unit coupled to each meter, said meter unit comprised of: i) an I/O (Input/Output) interface; ii) a memory device storing a unique identification number (ID); iii) an RF transceiver (i.e. transmitter+receiver); iv) a microcontroller;
b) at least one mobile relay comprised of: i) an RF transceiver; ii) a memory device; iii) a microcontroller;
c) a central station comprised of: i) a central computer; ii) an RF transceiver;
wherein said meter unit configured to periodically read its meter and store a data record containing at least said reading and said meter's ID, and forward stored data records to other meter units and mobile relays in its vicinity, and alter and store received data records, said mobile relay configured to automatically communicate data records from a meter unit to said central station, wherein at least one of said data records arrived from another meter.

2. A system and method according to claim 1, wherein said mobile relays travel randomly or semi-randomly related to said meters locations, or not necessarily aware to meters locations.

3. A system and method according to claim 1, wherein data is configured to flow or propagate from meter units to central station and/or vice versa.

4. A system and method according to claim 1, wherein said data records contain further data fields from the following list:
a) meter's reading time of day (TOD)
b) meter's status as battery condition and hardware failure
c) for each retransmission (“hop”) of a record: i) transmitting unit ID; ii) transmission TOD
d) accumulated number of hops made so far

5. A system and method according to claim 1, wherein stored data records are configured to be forwarded unless meet specific pre-defined data content criteria.

6. A system and method according to claim 1, wherein stored data records are configured to be forwarded unless meet one of the following criteria:
a) number of accumulated hops exceeds a predefined parameter
b) this record was already transmitted by this unit more than a predefined number of times
c) this record was already transmitted by this unit less than a predefined time ago
d) meter's reading TOD is later or earlier than a predefined value
e) meter's reading is invalid

7. A system and method according to claim 1, wherein data is configured to flow or propagate among meter units and mobile relays to the central station according to algorithms and/or routing tables stored in each unit, either pre-defined or configured to be dynamically updated.

8. A system and method according to claim 1, wherein communication is configured to be initiated by any of the following: meter unit, mobile relay, central station.

9. A system and method according to claim 1, wherein any of the following multiple access communication methods is applied: TDMA (Time Division Multiple Access); FDMA (Frequency Division Multiple Access); CDMA (Code Division Multiple Access); OFDMA (Orthogonal Frequency Division Multiple Access).

10. A system and method according to claim 1, wherein any of said RF transmitters and RF receivers, is configured to turn on, in specific time slots, either pre-defined or reconfigured during operation.

11. A system and method according to claim 1, wherein said RF receiver of mobile unit is configured to stay always or usually on.

12. A system and method according to claim 1, wherein RF transmitters and/or RF receivers are configured to be triggered by a signal input from an external device or component.

13. A system and method according to claim 1, wherein any of the following spectrum utilization methods is applied: single frequency, SS (Spread Spectrum), FHSS (Frequency Hopping Spread Spectrum), DSSS (Direct Sequence Spread Spectrum).

14. A system and method according to claim 1, wherein mobile relays are configured to communicate data records to central station indirectly, via further wireless or/and wireline communication links.

15. A system and method according to claim 1, wherein RF transceivers comprised in said meter unit and mobile relay are Bluetooth or WLAN (802.11) or ZigBee, or any other unlicensed ISM radio.

16. A system and method according to claim 1, wherein RF transceivers comprised in said mobile relay and central station are cellular network compatible, or Wi-Fi, or Wi-Max.

17. A system and method according to claim 1, wherein said meter is a remote controlled/monitored device applied to one of the following clusters: utility (gas, electricity, water); environmental (pollution, temperature, barometric pressure, humidity); seismic/water flow; surveillance (video, audio, access control); traffic (parking, speed control, traffic light monitoring and control); military reconnaissance; industrial (gas/oil/water/drilling or processing); vehicular monitoring (tachometer/speed recorder, toll payment); body carried/worn (heart monitor, blood pressure/diabetic monitor).

18. A meter unit coupled to a meter, for AMR, configured to periodically read its meter and store a data record containing at least said reading and the meter's ID, and communicate data records to other meter units and mobile relays in its vicinity, and to receive and alter and store and forward data records, said mobile relay configured to automatically communicate data records from a meter unit to a central station, wherein at least one of said data records arrived from another meter.

19. A mobile relay, for AMR, configured to communicate with meter units in its vicinity, said meter unit coupled to a meter and configured to periodically read its meter and store a data record containing at least said reading and the meter's ID, and communicate data records to other meter units and mobile relays in its vicinity, and to receive and alter and store and forward data records, said mobile relay configured to automatically communicate data records from a meter unit to a central station, wherein at least one of said data records arrived from another meter.

20. (canceled)
